(19) United States
(12) Patent Application Publication
(10) Pub. No.: US 2012/0296739 A1
(43) Pub. Date: Nov. 22, 2012

(54) System For Selling Products Based On Product Collections Represented In Video

(76) Inventors: Sukhinder Singh Cassidy, Atherton, CA (US); Diana Lynn Williams, Burlingame, CA (US)

(21) Appl. No.: 13/112,751

(22) Filed: May 20, 2011

(51) Int. Cl. G06Q 30/00; H04N 9/80

(52) U.S. Cl. 705/14.51; 386/241; 386/240; 386/E09.011

(57) ABSTRACT

A system for marketing products to customers includes an Internet-connected server and software executing on the server from a non-transitory physical medium, the software providing display of links to one or more interactive video showcases; tracking consumer actions during video consumption of a video showcase; re-purposing focus of video content based on the results of the tracked consumer actions; redirecting consumers to a product description page based on consumer selection of a product during video consumption; and conducting one or more transactions through the portal relative to products selected for purchase by the consumers.

### BACKGROUND OF THE INVENTION

1. Field of the Invention

The present invention is in the field of ecommerce, and pertains more particularly to methods and apparatus for video-based marketing of products to consumers over the Internet.

2. Discussion of the State of the Art

In the art of ecommerce, there are various types of websites accessible to Internet-connected users that sell products through web pages. Most such avenues utilize some checkout services, a shopping cart utility, and a method for marketing products to potential buyers.

One challenge with online shopping sites is that often products the consumer is really interested in are not presented first and foremost in terms of accessibility to the consumer navigating the site. Often consumers must search for product and may even be required to browse extensive catalogs for products. Another issue is that often products are minimally described and may be demonstrated in limited forms like still snapshots jpegs that may be enlarged. Description is often limited to a few bars under the picture of the item for sale.

Therefore, what is clearly needed is a video marketing system that enables a consumer to consume video about more than one product, and that fits synergistically into a specific product grouping or collection of several products the consumer might want to review and purchase.

### SUMMARY OF THE INVENTION

A problem stated above is that a more streamlined and style, advice, or tip-conscious process is desirable for an ecommerce sales portal that sells soft or hard goods such as women's clothing, bedding or stereo equipment, but many of the conventional means for streamlining the process from presentation to sale, such as multi-page catalogs, also create confusion and more complicated navigation tasks for users. The inventors therefore considered functional elements of an ecommerce website, looking for elements that exhibit interoperability that could potentially be harnessed to provide a sales presentation but in a manner that would be more flexible and not create confusion and more complicated navigation tasks for users.

Every ecommerce website is propelled by traffic, one by-product of which is an abundance of product views and sales resulting from those views. Most such ecommerce websites employ web servers, web interfaces and applications to conduct the business of and achieve the goals of the site, and web servers, web interfaces, and applications are typically a part of such apparatus.

The present inventor realized in an inventive moment that if, at the point of presentation, multiple products could be represented as a synergistic grouping or collection in a simple and streamlined manner in one or more client interfaces, significant increases in sales of represented products might result. The inventor therefore constructed a video showcase electronic magazine for showcasing products that are synergistically grouped that provided key commentary and allowed less time and complexity for product display and client navigation. A significant decrease in time from presentation to sale results with an increase in number of sales per sale window created.

Accordingly, in one embodiment of the present invention, a system is provided for marketing products to customers comprising an Internet-connected server and software executing on the server from a non-transitory physical medium, the software providing display of links to one or more interactive video showcases; tracking consumer actions during video consumption of a video showcase; re-purposing focus of video content based on the results of the tracked consumer actions; redirecting consumers to a product description page based on consumer selection of a product during video consumption; and conducting one or more transactions through the portal relative to products selected for purchase by the consumers.

In one embodiment, the links to interactive video showcases are displayed on a web page. In a variation of this embodiment, the web page is optimized for a mobile platform, application platform or televised platform.

In one embodiment, the consumer actions include computer mouse operations, keyboard operations, remote control or touch screen operations performed relative to content within video being consumed. In one embodiment, a video showcase includes a primary video and one or more sub-videos linked to the primary video from anchored positions within the primary video. In one embodiment, the link display includes one or more thumbnail pictures accompanied by general description.

In a preferred embodiment, a video showcase is a video story with commentary by one or more persons. In variations of this embodiment, a video showcase is one of a private sale, a live sale, a live auction, a personalized sale, or a group sale. In a preferred embodiment, a sub-video of a primary video has specificity to particular content in the primary video. In this embodiment, the particular content is product or a theme isolated from the rest of the products or stories in the primary video. In one embodiment, the products and/or commentary are time-stamped to enable video content thereof to appear in the primary showcase at specified times.

According to one aspect of the present invention, a method is provided for assembling and displaying video comprising the steps (a) creating a primary video with commentary about products; (b) creating separate sub-videos of specific products showcased in the primary video that are subject of the commentary of step (a); (c) time-tagging the product videos and linking them to the primary video; and (d) launching the primary video, incorporating the product videos into the primary video in order of the assigned time of appearance.

In one aspect of the method, links to the primary video are displayed on a web page. In a preferred aspect, the primary video is a video story with commentary by one or more persons. In a preferred aspect, in step (b), the separate videos are of products showcased in the primary video. In this aspect, the separate videos have specificity to particular content in the primary video. In one aspect of the method, in step (c), the product videos are time stamped relative to time points within the scheduled airing window of the product showcase video. In another aspect, in step (c), the product videos are time stamped relative to time points within the product showcase video play window.

In one aspect of the method, in step (d), selection of any of the products via interaction with the product video representing that product causes a more specific sub-video clip of the product to play within or alongside the main showcase video or the product. In this aspect, selection of any of the sub-video clips incorporated into the product showcase video redirects the user to a product description page with a link to a shopping cart for checkout.

### BRIEF DESCRIPTION OF THE DRAWING FIGURES

FIG. 1 is an architectural view of a communications network that supports distribution and consumption of a video magazine according to an embodiment of the present invention.

FIG. 2 is a plan view of a showcase video interface loaded with a showcase video according to an embodiment of the present invention.

FIG. 3 is a plan view of the showcase video interface of FIG. 2 further along in play of the showcase video.

FIG. 4 is a plan view of a products description page resulting from client selection of a product from a showcase video.

FIG. 5 is a process flow chart illustrating steps for interacting with a showcase video presentation according to an embodiment of the present invention.

FIG. 6 is a process flow chart illustrating steps for customizing a video sale to a client and serving the video sale to the client according to one embodiment of the present invention.

FIG. 7 is a block diagram illustrating web architecture associated with the showcase video marketing system of the present invention.

FIG. 8 is a UML diagram illustrating a model for a video showcase according to an embodiment of the present invention.

FIG. 9 is a process flow chart illustrating steps for recommending a product to a consumer according to an embodiment of the present invention.

### DETAILED DESCRIPTION

The inventors provide a video showcase, sales website and interface which allows clients to select products from put-together collections of products having synergy within the grouping. The present invention is described in enabling detail using the following examples, which may describe more than one relevant embodiment falling within the scope of the present invention.

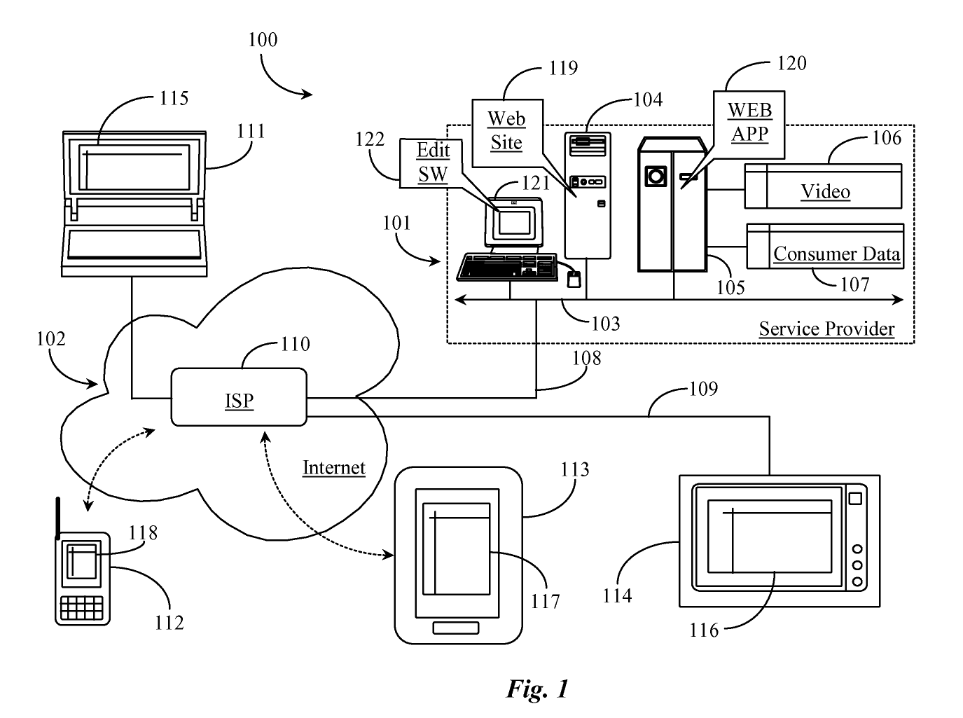

FIG. 1 is an architectural view of a communications network 100 that supports distribution and consumption of a video magazine according to an embodiment of the present invention. Communications network 100 includes an Internet network 102. Internet 102 is preferred as the primary carrier network because of its public accessibility. Cloud 102 represents all of the lines, equipment, and access points that make up the Internet as a whole including any connected sub-networks. Therefore, there are no geographic limitations to the practice of the present invention.

Internet 102 includes at least one Internet services provider (ISP) 110, which may be assumed operative for both wired and wireless appliances. A service provider 101 is illustrated in this example, and has Internet connection to Internet 102 via a local area network (LAN) 103 and an Internet access line 108. Edge routers, media gateways, and other applicable network bridging apparatus may be assumed present in this example though not specifically illustrated. Local Area Network (LAN) 103 is enhanced for the Internet with transfer control protocol/Internet protocol (TCP/IP) and other necessary protocols for practicing Internet-based ecommerce sales. In this example, service provider 101 is a company that markets clothing and other soft products to potential clients who access the service through a website such as website 119 running on a web server 104. Clothing a soft products are not limiting in the invention, as the system and methods described can be applied to essentially any sort of product, and to services as well.

Website 119 may require secure connection with ID and password protection for repeat customers that shop at the site as registered website members. Web server 104 includes a non-transitory digital medium that comprises all of the software and data to enable hosting and serving of web pages and associated data. Web server 104 is connected to LAN 103 and website 119 is hosted on the server and is accessed by customers of the service of the invention. LAN 103 supports an application server 105. Application server 105 includes a non-transitory digital medium that comprises all of the software and data required to function as an application server.

A Web application 120 is provided on application server 105 and is adapted to serve one or more showcase videos to customers who may access them through website 119. Application server 105 has connection to a mass repository 106 that comprises video and other applicable media. Application server 105 also has connection to a mass repository 107 that contains consumer data, including demographic data, profile data, current contact and payment information relative to site subscribers and first time customers, and historical data collected from transactions previously accomplished through the website. Repositories 106 and 105 may be optical or magnetic data storage mediums, and are illustrated as separate repositories just for convenience of description. They could be accomplished in a single physical repository, or over a larger number of repositories.

LAN 103 supports a media editing station 121. Media editing station 121 is a computing station having a non-transitory digital medium comprising all of the software and data required to enable function as a media editing station capable of producing and editing video and video commentary. A knowledge worker may operate station 121 to produce and edit video and video commentary using a video editing software (SW) 122. There may be several stations like station 121 operable within or associated with the premises of service provider 101.

Users may access website 119 through ISP 110 and Internet access line 108. Users (customers) may access website 119 or a version thereof from a variety of Internet-capable appliances. A laptop computer 111 is illustrated in this example and has a landline connection to ISP 110. A cellular telephone 118 is illustrated in this example as well, and has access to ISP 110 wirelessly. A touch screen notebook 113 is also illustrated in this example, and also has wireless access to ISP 110. Support or access networks may include the public-switched telephone network, or any wireless CDMA or other wireless carrier network. Access to Internet 102 may also be through a wireless fidelity (WiFi) network. In one embodiment of the present invention, website 119 and associated services may be accessed through web television (Web TV). A web-enabled television 114 has connection to ISP 110 via an access line 109 representing a television network. Television access may be accomplished through wireless satellite or cable television. The interface may be presented on a web page, rendered on a television, rendered on computer screen, or on a mobile or similar device without departing from the spirit and scope of the present invention.

In practice of the invention, service provider 101 offers its services through website 119 to the general public. Potential consumers operating appliances like appliances 111-114 may access the website and watch interactive videos of product collections with style-conscious commentary. The users may interact with the one or both of the video and associated links provided in the video interface to seek further information and to purchase one or more of the offered products. Laptop 111 has a version 115 of a video showcase page adapted for a laptop displayed on its display screen. Cellular telephone 112 has a version 118 of a showcase video adapted for cellular telephones displayed on its display screen. Touch-screen pad 113 has a version 117 of a showcase video displayed on its screen and adapted for touch screen use. Television 114 as a version 116 of a showcase video displayed on screen and adapted for remote control interaction.

A showcase video may be pre-scheduled for presentation or it may be available on demand. A showcase video is adapted to comprise visual media and commentary on several products that are related of function together. In this example the products are women's clothing and accessories. In other embodiments, men's clothing, children's clothing, shoes, accessories, health and beauty products, bedding, media, art, home and garden products, vintage clothing, technology products, collectibles, and antiques might be incorporated into a product video showcase without departing from the spirit and scope of the invention. In one embodiment of the invention other products that can be synergistically grouped may be sold through a video showcase sale, such as gardening products and any other consumer items.

Web application 120 includes all of the tools required to edit video and link video portions together to form a showcase video for presenting several products to a consumer. In one embodiment, a showcase video is a main video containing several snippets or sub-video clips. In this embodiment the sub-video clip may represent one of the products grouped for sale or a few of the products grouped for sale. A video showcase may be a collection of sub-clips played back as a video with commentary. In a preferred embodiment, the video is interactive and contains links to other areas of the website, like a product page, specific sub-clips or a checkout page.

A consumer may access website 119 through any of the illustrated appliances and may consume video presentations that are scheduled or that are available on demand or at specific times. As a consumer watches the video and listens to the commentary, the user may click on any indication of a product in the video to quickly load and view a sub-clip available for that specific product. Likewise, thumbnails of the sub-clips may be provided within the video or just outside the boundary of the active video window. Advertising from the site may be proactive and contests may be provided to spur activity at the site. In one embodiment dynamic product collections are assembled and represented in a main or primary showcase video, each separate product also depicted in a separate product video or sub-clip.

In some cases a video presentation is broadcast available to a number of customers simultaneously. This sort of broadcast necessarily limits the selective activity of viewers. For example, in this case individual customers would not be able to stop the video, divert to different material and return, and the like, as this would serious effect the viewing experience of the other users. But in some cases certain customers may be able to view video presentations privately, and may then have a richer selective and interactive experience.

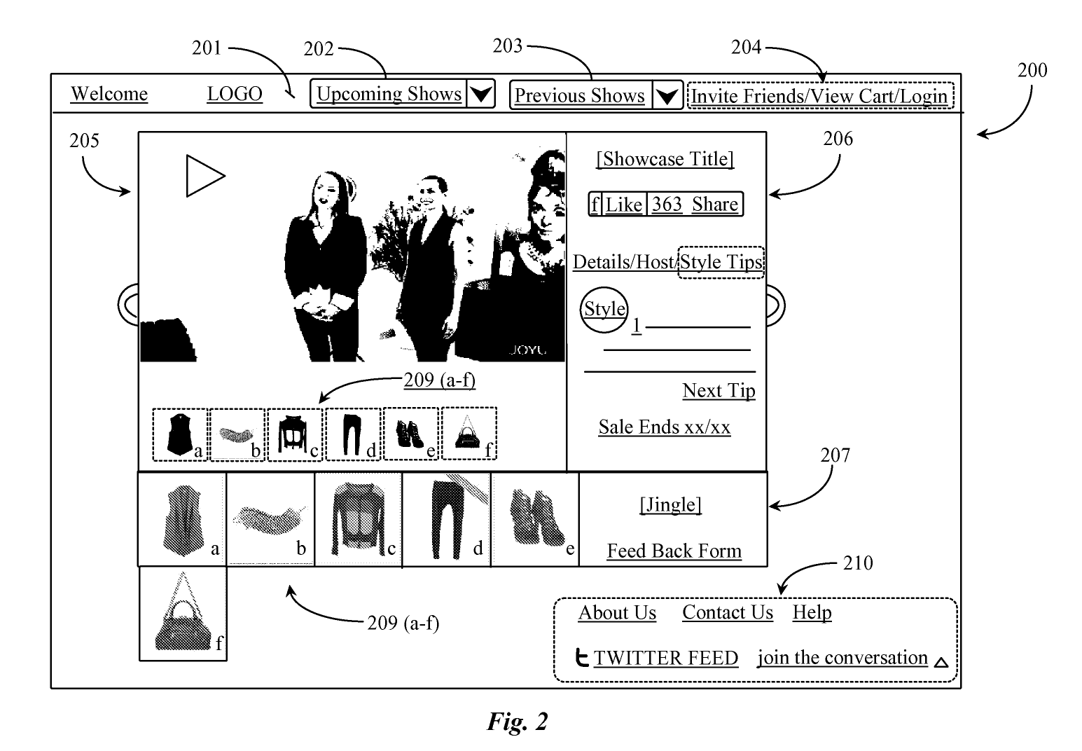

FIG. 2 is a view of a showcase video interface 200 presenting a showcase video according to an embodiment of the present invention. Interface 200 is accessible and displayable through a browser operating on the user's computerized appliance.

Interface 200 has a welcome bar 201 that may include a logo of the host or sponsoring company. The logo may change according to negotiated arrangements such as in a co-branding relationship, for example. Interface 200 includes a drop-down menu 202 of upcoming shows that will be presented on certain dates. Shows may be scheduled to air for the general public, or for a smaller, select audience. A showcase video may also be presented simultaneously with a live event, such as a live auction for example. Interface 200 also includes a drop-down menu 203 that lists previous shows that have already aired but are still available for viewing. Showcase videos may be tailored for retailer sales, marketplace sales, and crowd-sourced sales. Sale formats may include private sales, live sales, personalized sales, group sales, and live auction. Shows may be accessed on demand, or by schedule, or both. Live streaming technology may be used to live-stream showcase videos in some embodiments. Welcome bar 201 also includes a grouping of action buttons 204 that enable invitation of friends to watch the video or visit the site; enable the user to view a shopping cart associated with the check-out page of the website; and enable a customer to perform a secure log-in to the website or interface.

A showcase video 205 is illustrated in this example and is associated with a universally understood play button. Links to this video and other showcase videos may also be listed on the home page of website 119 of FIG. 1. Video showcase 205 includes two persons in this example, one providing commentary about the offered products and the other modeling the products. The showcase video may, in one embodiment, be a compilation of smaller product videos without departing from the spirit and scope of the present invention. Product representations 209 (a-f) are illustrated outside of the video window below the window as product video snippets or sub-clips representing a vest (a), a bracelet (b), a blouse (c), pants (d), boots (e), and a handbag (f). All of these products are offered together in one showcase video. The separate products have been pre-aggregated as a collection of products that form a synergistic relationship with one another as a group. In this case, the products all go together from a style sense.

In one embodiment, the separate sub-clips 209 (a-f) may be stitched together to form the primary showcase video 205. In that case each of the sub-clips representing a single product would likely include the same two persons involved in the showcase presentation. The beginning of video 205 shows vest (a), and presumably the rest of the products in the stitch order. In one embodiment product representations 209 (a-f) are embedded as links directly into the showcase video 205 (may be small thumbnails with broken borders). In this case, any of the thumbnails may be selected as the main video plays to “jump” to the section describing the product represented in that snippet. In preferred embodiments the system records and tracks consumer actions relative to the website and video. Based on these interactions, private collections of product types known to interest a specific customer may be quickly stitched together and offered as a private sale video to that customer. Similarly, group demographics may be recorded and used to create a showcase video targeting that specific group of customers.

In one embodiment, users may interact with video 205 by clicking on or otherwise activating embedded links in the video that are associated with the individual ones or products represented in the video. In this embodiment, the links are links to separate videos and when activated may cause a separate video snippet of the product of interest to display. This separate video, while not part of the original showcase, may be activated to play in a separate window within the active video interface, or in place of the active showcase video. After the separate video is viewed and terminates the main showcase video may be continued by default. In this embodiment, it is also possible to “jump” to any of the products showcased by clicking on a provided representative link to that product video snippet. In the case of separate product video snippets that are not incorporated into the showcase video, but are invoked from interacting with the video or links associated with the active video, the level of detail may be increased giving the consumer a more detailed look and possibly a more detailed description then would otherwise have been provided in the actual showcase video.

Video showcase 205 may be minimized, maximized, and played full screen like any other computing screen-adapted video display interface. A data block 206 is illustrated adjacent to video showcase display 205. Data block 206 may include details such as the title of the showcase video. For example, the video might be titled [“six great items to wear for your spring party”]. The number of items showcased in a showcase video may be greater or less than six items without departing from the spirit and scope of the present invention. Block 206 includes a Facebook™ link for stating how many persons have watched and like the video showcase. A Facebook™ link for sharing the showcase video with other Facebook™ users is provided. Customers could be able to add or view their own comments and tips or comments/tip of other users based on a homegrown or third-party system. Links or extension to other social media services may also be provided in interface 200. Block 206 further includes a grouping of action buttons that enable redirection to a product details page; enable the customer to learn more about and perhaps contact the host of the showcase; and enable the customer to review several style tips for wearing the instant collection of products. An indication of when the sale expires is also present in details block 206.

An additional data block 207 is provided beneath block 206 that includes any corporate jingle or slogan and a link to a customer feedback form. A data block 210 is provided at lower right and includes the action buttons About Us, Contact Us, and Help. A link to a Twitter™ feed is provided for customers to subscribe to. A link to join an open chat line is also provided. Other links and additional functionality may be provided in interface 200 without departing from the spirit and scope of the present invention. Fast links to checkout may be provided as well as a group-buy button for adding all of the showcased products to a shopping cart at some discount and proceeding directly to checkout. This may be done before, after, or during play of the video showcase. Interface 200 may appear differently on different appliances. Hypertext Transfer Protocol (HTTP) and wireless application protocol (WAP) are just a few configurations that are available for media dissemination on different appliances.

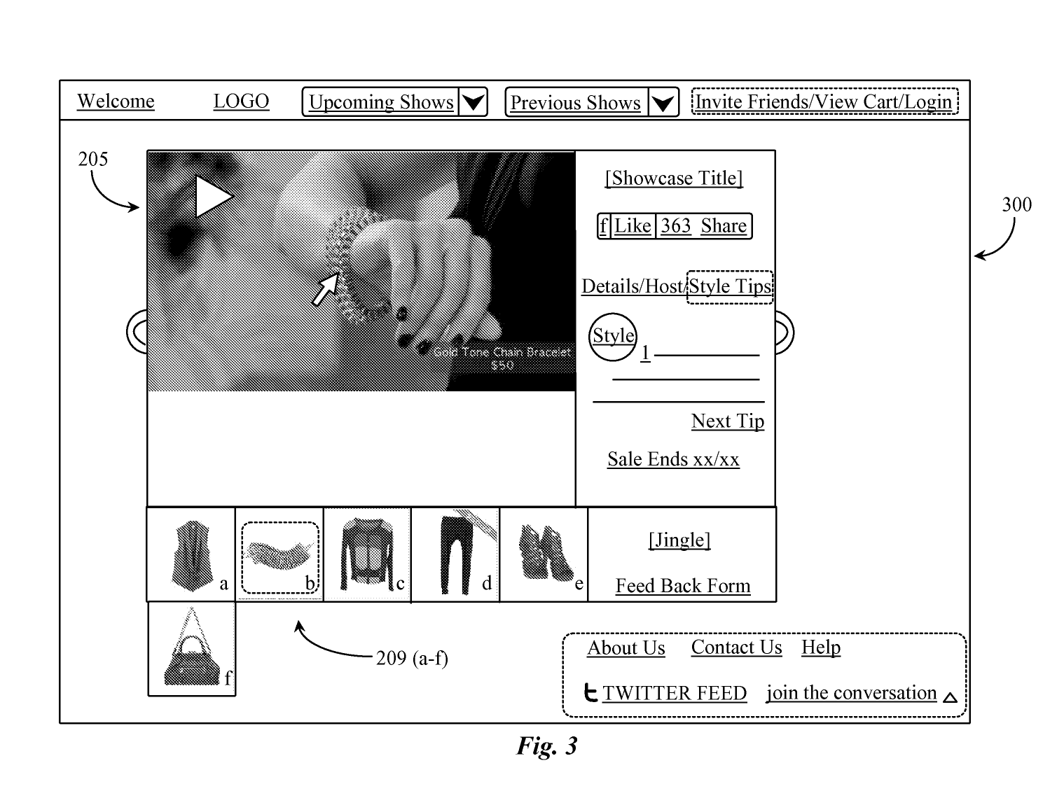

FIG. 3 is a view of the showcase video 205 of FIG. 2 further along in play of the video. Interface 300 shows the same showcase video of FIG. 2 further along and illustrating a bracelet (209 b) in some detail on a model's wrist. In this embodiment, a user may click on the bracelet on the model's arm to cause a sub-clip based on the bracelet to appear separately or in the same window. In one embodiment, clicking on the bracelet on the model's wrist causes a re-direct action to a product page giving greater details about the bracelet that may not be included in the main video. A visual indication, such as a color patch or mini logo may appear in the video over embedded links in the video so a consumer knows when to click on or otherwise interact with a product in the video. In this example, the consumer may, instead of getting more detail about the bracelet, click instead on boots 209 (e) causing the main video to jump to that section showing the model wearing the boots. In that case the consumer may double click the boots worn in the video to cause a separate more-detailed video snippet to play, or to be re-directed to the product page having greater details about the boots.

In one aspect of the present invention all of the product representations showcased in video 205 or in like videos from the website are tagged with one or more keywords and may be part of more than one group of items. For example, gladiator boots 209 (e) may be part of several other showcase videos and a link may be provided that enables a customer to see all of the collections to which this pair of boots belongs. Video content may include pre-planned and dynamically inserted commentary. Content may include pre-produced editorial and testimonial content around the showcase video and separate product snippets. Content may include user-generated content such as customer feedback comments, tweets, and interactions via internal features or other social media sites. Any content may be programmed to appear within or alongside the video showcase at specified cue points. Videos, sub-clips, and products can be tagged with metadata, such as personal style, brand, color, trend, compatibility, category, or the like. Products and commentary may be time-tagged to appear at certain points in the video, may be associated with specific piece(s) of content, and may be associated with multiple video clips without departing from the spirit and scope of the present invention. In addition to products and commentary, sub-clips, tips, advice, how-to information, and other presented data can be time stamped or tagged to appear in the main video or story when desired.

In one embodiment a video showcase may include a “guest” product that is introduced into an established collection of products created by the host or any other entity. Guest products might be products created by individual designers that want to have a platform for selling those products. A “guest product” might require review and acceptance before it becomes a “collection product”. If a “guest product” sells well, other products from that guest designer might be introduced into various product collections, or that designer may be allowed to create a showcase video of their own collection of products.

In one embodiment of the present invention, showcase videos, interactive areas within a video, sub-clips, product collections, and individual product representations (images) may be tagged with one or more keywords. Tagging may be practiced by companies hosting product, website knowledge workers, or by consumers practicing folksomony. Tagging may be used to incorporate the following descriptors, for example:
Category, Product Type, Room, Collection
Trend, Style, Occasion
Brand, Fabric/Material, Color
Personal Style
Size, Body Type
Compatibility, Technology
Host, Channel, Show, Program
Video
Products/Listings

The metadata content associations among video, video sub-clips, and/or products are thought by the inventors to be very important to the shopping experience. This structured data can be used as an alternative navigation path around the website, to search for videos, sub-clips, content collections, and products. Tags may be used to connect products together in “product collections” that can also be produced into showcase videos. In one embodiment of the present invention, a hybrid search function is provided that returns mixed media results like primary video, sub-clips, commentary, and products, and conversations in a single search results page or listing.

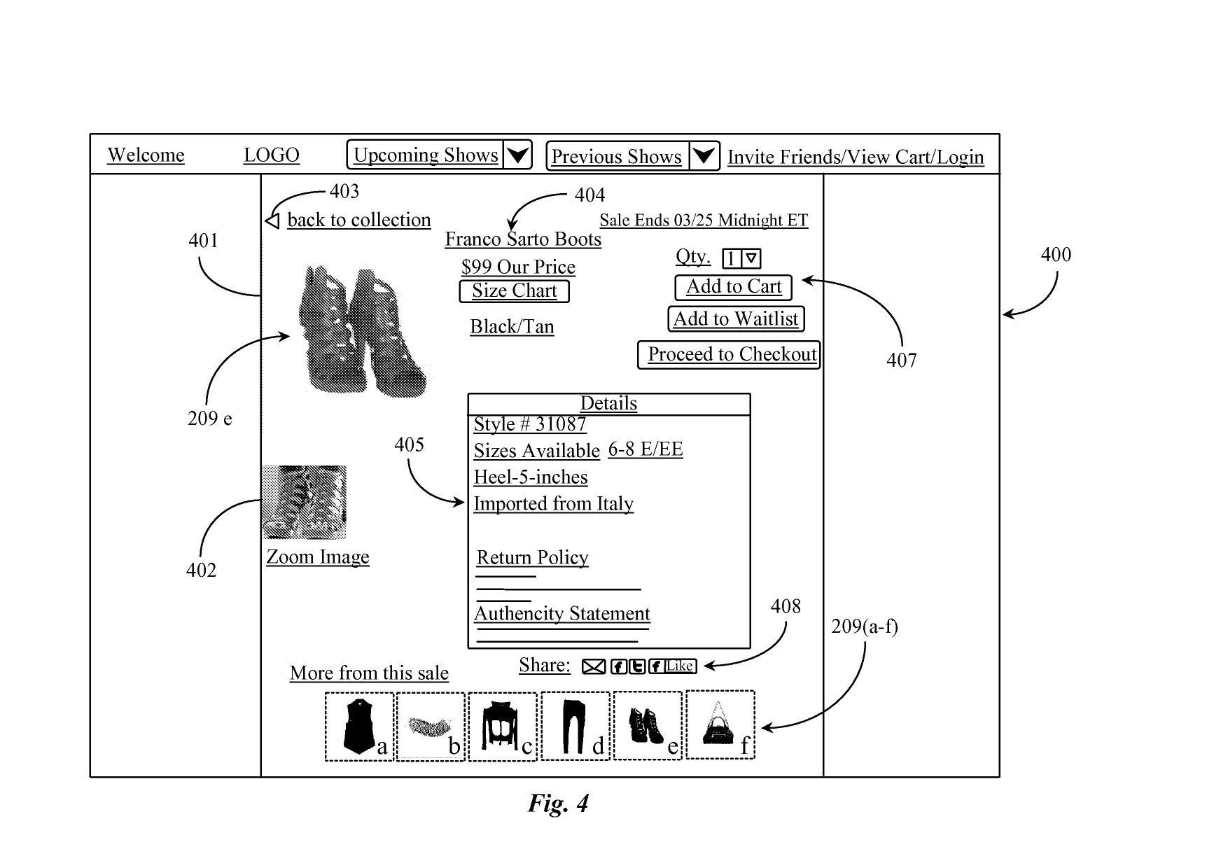

FIG. 4 is a view of a products description page 400 resulting from client selection of a product from a showcase video. Product description page 400 is a browser-based web page and shares the same welcome bar as the video page in this example. A product details window 401 is provided. Product 209 (e) is highlighted in window 401 with a thumbnail representation. A thumbnail image 402 is provided of product 209 (e) showing the product being worn by the model in the video showcase. Thumbnail 402 may be a link to a video sub-clip. A function for zooming the image is provided beneath the image.

A navigation back-button is provided for navigating back to the original product collection. A detail block 404 is provided that lists the brand name Franco Sarto Boots, the price for the boots ($99.00), and the available colors black or tan. Block 404 includes an interactive size chart enabling the consumer to indicate shoe size from the available sizes. A details window 405 provides further product details including a style number (31087) the available sizes, the height of the heel, and an indication that the product was imported from Italy. Window 405 includes a return policy statement and an authenticity statement.

A transaction interface 407 is provided for the customer to add the product to a shopping cart utility or to a transaction wait list for reserving the product for a later purchase. A link to a checkout page is also provided as an option associated with transaction interface 407. At the bottom of product page 400, the rest of the collection is illustrated under “More from this sale”. All of the products 209 (a-f) associated with the sale are displayed. Each of the illustrated thumbnails may be links to the product sub-clips that make up the showcase video.

In one embodiment, the product sub-clips are independent from the showcase video and provide views and details in addition to the main video. In one embodiment, each of the illustrated thumbnails may also be linked to their own detailed product pages. An indication of when the sale ends is also visible in window 401. A social interaction links 408 for email sharing, commenting, Facebook™ action, and Twitter™ actions are provided. In a preferred embodiment of the present invention, products may be aggregated and presented as suggested products according to personalization criteria. Personalization can take the form of implicit personalization or explicit personalization. Implicit personalization involves tracking and recording customer actions, such as clicks on videos, stories, and product representations, and recommending new products, videos, and content based on analysis of those actions. Explicit personalization involves developing likes and dislikes of customers by allowing customers to create a profile, which may include likes and dislikes so that only products the customer likes are presented.

Social media integration can happen both onsite and offsite. Social interaction integration may include such conventions as Facebook™ or a user-specific like/send buttons on products, hosts, sub-clips, videos, collections, and the homepage. Customers may Tweet in a question and a video host may answer questions. Blogging may be hosted onsite or off site. Contests may be offered including voting on products or collections of products. User-generated tips, advice, comments, reviews and chats may be offered in the form of text or video. There are many possibilities.

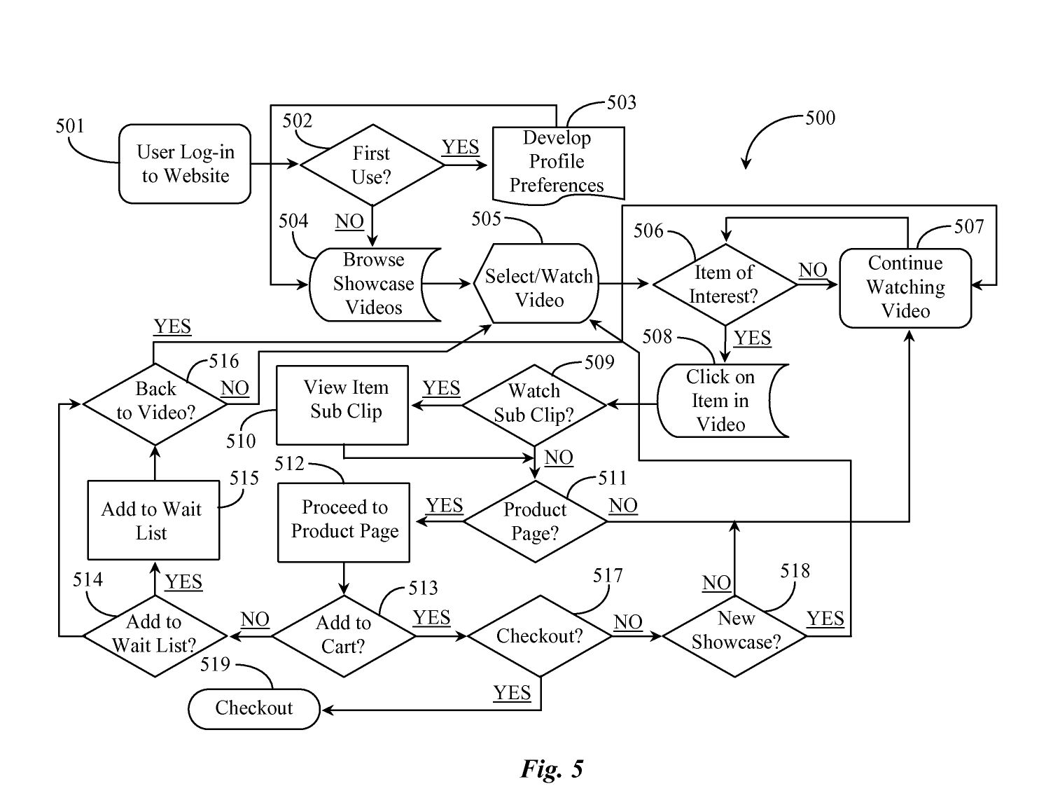

FIG. 5 is a process flow chart 500 illustrating steps for interacting with a showcase video presentation according to an embodiment of the present invention. At step 501, a user logs into the website. The system decides at step 502 if the user is a repeat customer or a first time user. If the system determines through identification that the user is new or a first time user, then at step 503, the system may engage the user to register and begin developing a profile including listing of likes and dislikes relative to content that might be presented to that user in the future. If the system determines that the user is a repeat customer and not a first time user, the process moves to step 504 and the user is allowed to browse showcase videos. Similarly, after a first time user registers with the site or otherwise begins developing a profile and stating of preferences, the user may begin exploring available showcase videos.

It is noted herein that in one embodiment shows are part of a story that can be consumed by the customer and showcase videos may be provided on demand, scheduled to air, or dynamically put together from product sub-clips. At step 505 the user may select or otherwise begin watching a showcase video. At step 506 the user determines if there are any items of interest in the showcase video. If the user does not become interested in one or more of the showcased products, the user may simply continue watching the showcase video at step 507. In this event the process may loop back to step 506 until the user interacts with a product in the video. In one embodiment, step 507 may be replaced with a step for terminating the current video and watching a subsequent video, or one that might be suggested by the system based analysis of user input or demographics.

At step 506 if the user sees an item or product of interest, the user may click on or otherwise interact with the item or product of interest. The process may continue to step 509 where the user may have the opportunity to view a more-detailed product sub-clip and commentary. If the user wishes to view a sub-clip of the product of interest, the user may consume the sub-clip in step 510. If the user does not wish to view a sub-clip at step 509, the process may move to step 511 where the user may decide to view a product page instead.

If the user decided to view the product sub-clip at step 510, the process may move to step 511 whether or not the user is still interested in the product after viewing the clip in step 510. If the user does not wish to view the product page of the item of interest, the process may move back to step 507 and the user may continue to watch the original showcase video. In one embodiment, the user may be given the option of viewing more than one product sub-clip of the item of interest. Sub-clips of like products may also be shown to the user. These sub-clips may be of related products that belong to other showcase videos or product collections. It is noted herein that at any time during the process of watching video and interacting with content, the user may proceed directly to checkout for the entire collection or for any product of interest the user wishes to purchase.

If the user determines to view the product page of an item of interest in step 511, that user is directed to a product page for that product similar too product page 400 described with reference to FIG. 4 above. While viewing the product page of a product of interest the user may determine if they wish to add that product to a shopping cart utility at step 513. In the event that the user determines not to add the product to a shopping cart utility at step 513, the process may move on to step 514 asking the user if they wish to add the product to a wait list, reserving the product for a later transaction. If the user determines not to add the product to a wait list, the process may move on to step 516 where the user may be prompted to return to the original showcase video.

If the user determines not to go back to the original selection at step 516, the process may move back to step 505 where the user may select a different showcase video to watch. If the user determines to add the product to a wait list at step 514, then the system adds the product to a waiting list for that user in step 515. The process then resolves to step 516 prompting the user to return to the original video to view the rest of the products if that user had not yet viewed them. If at step 516, the user determines to return to the original showcase video, the process moves back to step 507 and the original presentation may be re-activated or resumed.

If the user determines to add the product to a shopping cart utility at step 513, the user may be prompted to determine whether to proceed to check out at step 517. If the user decides to proceed to checkout at step 517, the process moves to the checkout page at step 519 where the user may purchase the product or products of interest. If the user determines not to proceed to checkout at step 517, the user may be given the opportunity of viewing a new showcase video. If the user determines not to watch a new showcase video at step 518, the process may move back to step 507 where the user may continue watching the original showcase video. If the user determines to watch a new showcase video at step 518, then the process may move to step 505 where the user is enabled to browse and select a new showcase video presentation for viewing. Incentives may be provided throughout the process to proceed to checkout. For example, a pop-up note may appear in the user interface suggesting a 20% discount if all of the showcased products are purchased within a certain time frame. Likewise other videos may be aggregated or dynamically stitched together for the user if there is ample evidence of an increased probability of a sale for specific items of interest.

It is noted herein that process flow chart 500 illustrates steps for navigating the video sale and there may be many junctions in the process where a user may be prompted to proceed to checkout, watch a custom video, share a product, receive a discount or prize or some other offer made proactively during the process. The user may engage in any subsequent path without departing from the spirit and scope of the present invention.

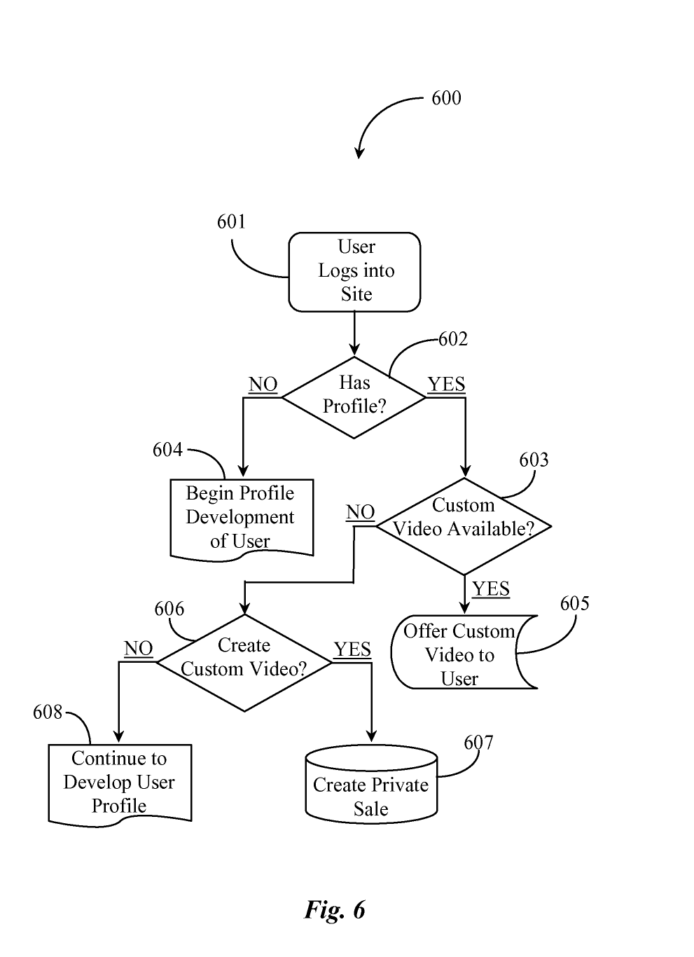

FIG. 6 is a process flow chart 600 illustrating steps for customizing a video sale to a client and serving the video sale to the client according to one embodiment of the present invention. At step 601 a user logs into the website. The system may make a determination about whether the user has a profile or not at step 602. If the system determines that the user does not have a profile at step 602, the system may prompt the user to register with the site and begin a profile at step 604. In this case, the process may end until there is enough data about the user available to create a custom video sale, a private video sale, or a collection of existing videos or sub-clips selected for that user. If the user has a profile at step 602, the system may then determine at step 603 whether there is already a custom video sale or curation put together for that user.

If at step 603, there are no custom videos yet created for that user, the system make a determination about whether a custom video or curation should be created for this user at step 606. Criteria for producing a custom video for a user may take into account income, demographics, implicit/explicit likes, implicit/explicit dislikes, body shape, body type, style and so on. If at step 606 there is not enough data to justify a private or customized video sale for that user, the process may move on to step 608 where the system continues to build upon the user data such as profile data and recorded activities of this user at the site.

If there is already a custom video created for this user at step 603, then the system may offer the custom video to the user for viewing at step 605. If the system determines that a custom video should be created at step 606, then a knowledge worker or other authorized person may create a custom video or private sale for that user at step 607. In one aspect custom collections of product are archived and may be reserved to other users who fit the demographics of that particular custom sale video. In one aspect, a customer may recommend that a custom video be put together for another user whether that user has registered with the website or not. There are many possibilities.

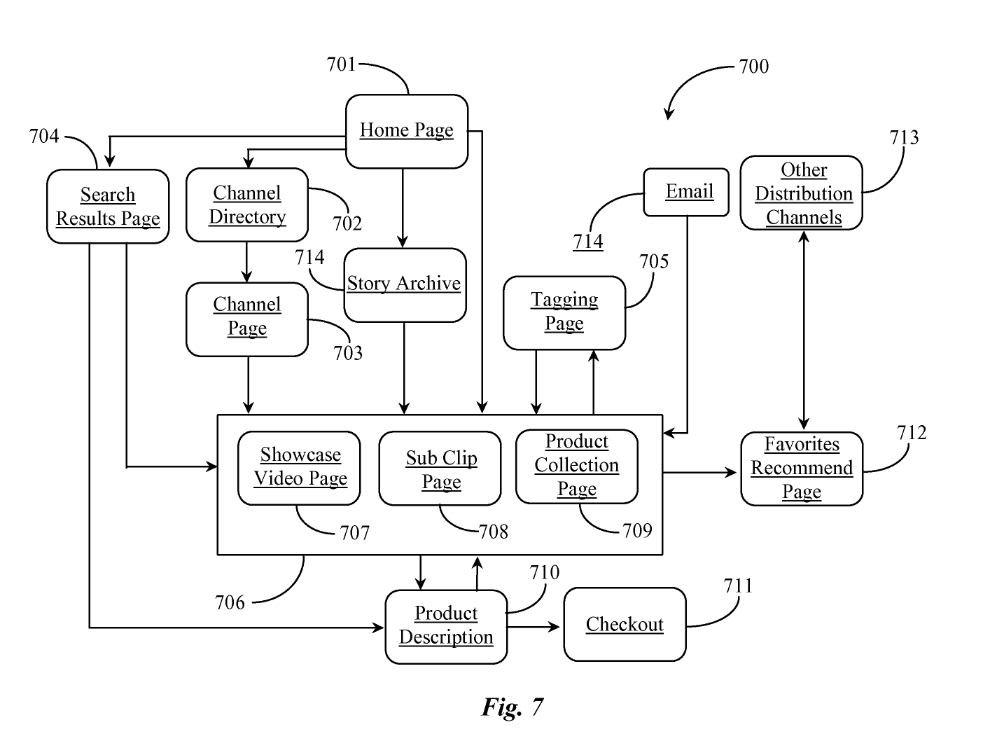

FIG. 7 is a block diagram illustrating website architecture 700 associated with the showcase video marketing system of the present invention. Website architecture 700 begins with a home page 701. Homepage 701 may require registration and membership maintenance. Homepage 701 may be personalized for each registered member of the site. Personalization of homepage 701 may be implicit or explicit. Home page 701 may have links to a “story”, which is an entity that includes a video page 707 for presenting showcase videos, a sub-clip page 708, which aggregates product sub-clips for one or more video sales and for independent viewing, and a collection page 709, which aggregates video sub-clips and content that may pertain to multiple video sales and collections. In a variation of the embodiment above, the experience enabled by the home page is optimized as an independent application for television, mobile devices, personal computers or other relevant devices, like a pad device for example.

Home page 701 may link to a channel directory page 702, which links to a channel directory for aggregating channel pages such as subsequent channel page 703 linked from the directory. Channel page 703 aggregates some content, video, host and/or product. Home page 701 links to a search results page that may be returned as a result of a user-activated search by tag word, by key word, and/or by titles for specific videos, content and product. A search interface may be provided on the home page. A user may navigate a search result page such as page 704 to retrieve a “story” like story 706. A user may navigate search result page 704 to retrieve a product description pages, product commentaries, product sub-clips, and so on. In one embodiment, a user may navigate search result page 704 to retrieve a combination of video, subclips, and/or product results.

A tagging/classification page or interface 705 is provided that enables users to tag/classify product representations such as video images, and the like with keywords or phrasing enabling others to find the resources. Tag page 705 aggregates videos content and product associated to that tag word. Tag clouds may also be presented wherein more popular tags are indicated by larger font or some other visual indicator. In this architecture, the tagging page is accessed from the story page, however links can be provided to the tagging page from the home page if desired.

A product description page 710 is provided and can be accessed from the story block 706. Product description page 710 provides product information along with links to video, sub-clips, collections, content, and other products. Product information page 710 may also include tag links. Checkout page 711 is accessible from the product information page, in this example, but may be made accessible from the story block 706 bypassing the product description page 710 if desired.

Architecture 700 includes website email account 714 and integration to other distribution channels 713. Site email may include sale emails, order confirmation, and shipping confirmation emails. Site email may be extended to personalized emails (implicit/explicit) and may also include social interaction site tie-ins. In one aspect, web architecture 700 also includes a favorites page 712, which may include recommendations for specific collections and products made by the registered user of the page. A video story archive page 714 is included in website architecture 700 and aggregates all of the past video shows including commentaries and related sub-clips for review by users.

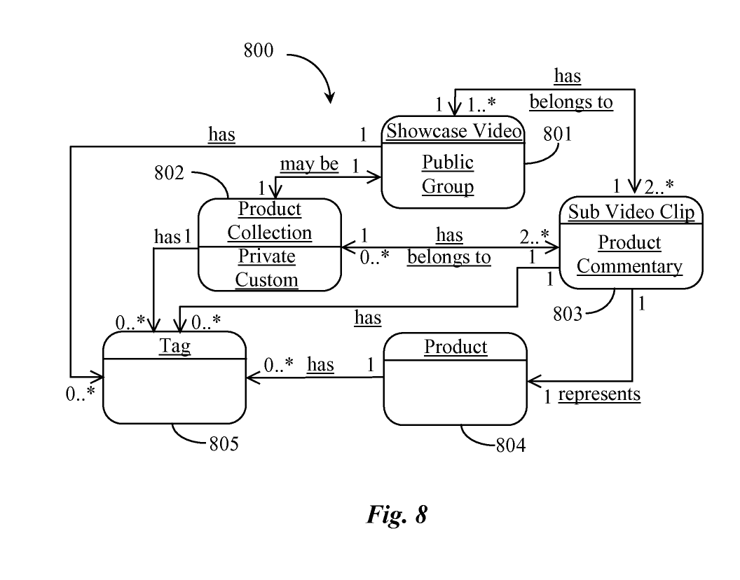

FIG. 8 is a UML diagram illustrating a model 800 for a video showcase according to an embodiment of the present invention. Model 800 is of a Showcase Video 801 adapted to be presented to the general public or a specified group of users. Showcase Video 801 has two or more Sub-Video Clips 803 associated with it. A sub-video clip 803 may belong to one or more showcase videos. Sub-Video Clip 803 has specificity to a product and commentary around that product. In one embodiment, a reverse hierarchy exists, in that the primary video is accessed via the product representations or via the sub-videos.

Showcase video 801 may be a Product Collection 802 of products reserved for a private video sale or a custom video sale. Product collection 802 has two or more sub-clips each representing a product for sale. A sub-clip may belong to 0 or more product collections. A showcase video is a product collection for sale to the public or a specific group. Showcase video 801 has 0 or more tags assigned to it. Product 804 has 0 or more tags assigned to it. Sub-clip 803 has 0 or more tags assigned to it. Product collection 802 has 0 or more tags assigned to it. Each component tagged is independently searchable using a tag word in the keyword field. The search interface used to search by tag may also accept standard descriptive keywords as input.

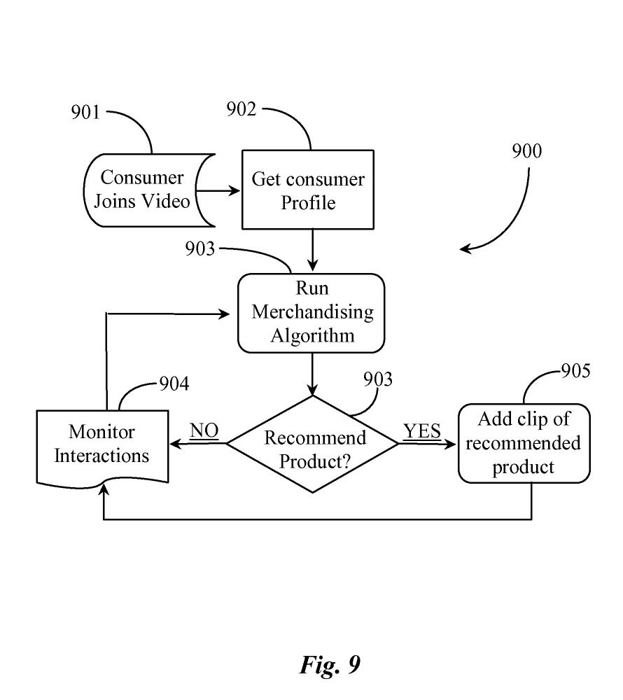

FIG. 9 is a process flow chart 900 illustrating steps for recommending a product to a consumer according to an embodiment of the present invention. At step 901, a consumer joins or begins watching a showcase video or a video collection. It is assumed in this example that the consumer is a repeat customer with profile. At step 902 the system retrieves the consumer profile. At step 903, the system runs a merchandising algorithm against the profile information to see if any products should be recommended to this consumer.

At step 903 the system determines, based on results of the algorithm, if a product should be recommended. At step 903 if the system determines that there is not enough data to recommend a product, the process moves to monitoring the interactions of the consumer at step 904. At step 903, if the system determines to recommend a product based on the results of the merchandising algorithm, then at step 905 the system adds a sub-clip of the recommended product to the list of clips shown to the consumer. New products, product collections represented by video, and showcase videos may all be subject to recommendations to consumers by the system based on data known about the consumer including demographics, profile data, purchase history, payment history, status, and stated likes and dislikes.

It will be apparent to one with skill in the art that the showcase video marketing system of the invention may be provided using some or all of the mentioned features and components without departing from the spirit and scope of the present invention. It will also be apparent to the skilled artisan that the embodiments described above are specific examples of a single broader invention that may have greater scope than any of the singular descriptions taught. There may be many alterations made in the descriptions without departing from the spirit and scope of the present invention.

What is claimed is:

1. A system for marketing products to customers, comprising:
an Internet-connected server; and
software executing on the server from a non-transitory physical medium, the software providing:
a display of links to one or more interactive video showcases;
tracking consumer actions during video consumption of a video showcase;
re-purposing focus of video content based on the results of tracked consumer actions;
redirecting consumers to a product description page based on consumer selection of a product during video consumption; and
conducting one or more transactions through the portal relative to products selected for purchase by the consumers.

2. The system of claim 1, wherein the links to interactive video showcases are displayed on a web page.

3. The system of claim 2, wherein the web page is optimized for a mobile platform or application platform.

4. The system of claim 1, wherein the consumer actions include computer mouse operations, keyboard operations, remote control or touch screen operations performed relative to content within video being consumed.

5. The system of claim 1, wherein a video showcase includes a primary video and one or more sub-videos linked to the primary video from anchored positions within the primary video.

6. The system of claim 1, wherein the link display includes one or more thumbnail pictures accompanied by general description.

7. The system of claim 1, wherein a video showcase is a video story with commentary by one or more persons.

8. The system of claim 1, wherein a video showcase is one of a private sale, a live sale, a live auction, a personalized sale, or a group sale.

9. The system of claim 5, wherein a sub-video of a primary video has specificity to particular content in the primary video.

10. The system of claim 9, wherein the particular content is product or theme isolated from the rest of the products or story in the primary video.

11. The system of claim 1, wherein the products and/or commentary are time-stamped to enable video content thereof to appear in the primary showcase at specified times.

12. A method for assembling and displaying video comprising the steps:
(a) creating a primary video with commentary about products;
(b) creating separate sub-videos of specific products showcased in the primary video that are subject of the commentary of step (a);
(c) time-tagging the products, sub-videos videos and/or commentary and linking them to the primary video or a sub-video; and
(d) launching the primary video, incorporating the sub-videos into the primary video in order of the assigned time of appearance.

13. The method of claim 12, wherein links to the primary video are displayed on a web page, mobile, pad, application or television.

14. The method of claim 12, wherein the primary video or sub-videos are a video story with commentary by one or more persons.

15. The method of claim 12, wherein in step (b), the sub-videos could be of products or of subclips based on in the primary video or mini-versions of a larger video.

16. The method of claim 15, wherein in step (b), the sub-videos could have specificity to particular content in the primary video.

17. The method of claim 12, wherein in step (c), the sub-videos and tips could be time stamped relative to time points within the scheduled airing window of the primary showcase video or sub-videos

18. The method of claim 12, wherein in step (c), the sub-videos are time stamped relative to time points within the product showcase video play window.

19. The method of claim 12, wherein in step (d), selection of any of the products via interaction with the product video representing that product causes a more specific sub-video clip of the product to play within, replacing or alongside the main showcase video.

20. The method of claim 19, wherein in step (d), selection of any of the sub-video clips incorporated into the product showcase video redirects the user to a product description page with a link to a shopping cart for checkout.
